(19) United States
(12) Patent Application Publication
(10) Pub. No.: US 2013/0308809 A1
(43) Pub. Date: Nov. 21, 2013

(54) LOUDSPEAKER ARRANGEMENT

(71) Applicant: Gary Taylor, Cardiff (GB)

(72) Inventors: James Thompson, Cardoff (GB); Gary Taylor, Cardiff (GB)

(21) Appl. No.: 13/599,690

(22) Filed: Aug. 30, 2012

(30) Foreign Application Priority Data
Aug. 30, 2011 (EP) 11 179 330.3

(51) Int. Cl. H04R 1/02

(52) U.S. Cl. CPC H04R 1/021
USPC 381/332

(57) ABSTRACT

A loudspeaker arrangement is disclosed that comprises a hollow box-like enclosure having rigid walls in which a loudspeaker opening and a vent hole are formed; a loudspeaker which is arranged in or at the loudspeaker opening and sealingly secured to the enclosure; and a protective panel which is arranged in or at the vent hole and sealingly secured to the enclosure, wherein the panel comprises at least one gas-permeable and liquid-impermeable membrane.

### CLAIM OF PRIORITY

This patent application claims priority from EP Application No. 11 179 330.3 filed Aug. 30, 2011, which is hereby incorporated by reference.

### FIELD OF TECHNOLOGY

The invention relates to loudspeaker arrangements having an enclosure with a loudspeaker mounted therein.

### RELATED ART

Vented loudspeakers have a vent hole (including tubes, ports, openings etc.) that are formed in a hollow box-like enclosure containing a loudspeaker. Normally, an enclosure without a vent hole would suffer from the pressure differentials due to environmental conditions, causing the piston (cone) of the loudspeaker to either be displaced into or out of the enclosure, resulting in a reduction in sound quality. Adding a vent hole to the enclosure removes this pressure differential problem but can potentially result in a reduction in sound quality, as well as providing a moisture and dirt ingress path into the enclosure, which again, can result in reduced sound quality. There is a general need for an improved loudspeaker arrangement that overcomes the problems outlined above.

### SUMMARY OF THE INVENTION

A loudspeaker arrangement comprises a housing having rigid walls in which a loudspeaker opening and a vent hole are formed; a loudspeaker is arranged in or at the loudspeaker opening and sealingly secured to the housing; and a protective panel is arranged in or at the vent hole and is sealingly secured to the enclosure, wherein the panel comprises at least one gas-permeable and liquid-impermeable membrane.

These and other objects, features and advantages of the present invention will become apparent in the detailed description of the best mode embodiment thereof, as illustrated in the accompanying drawings. In the figures, like reference numerals designate corresponding parts.

### DESCRIPTION OF THE DRAWINGS

Various specific embodiments are described in more detail below based on the exemplary embodiments shown in the figures of the drawing. Unless stated otherwise, similar or identical components are labeled in all of the figures with the same reference numbers.

FIG. 1 is a cross-sectional view of a loudspeaker arrangement in which a gas-permeable and liquid-impermeable panel covering the vent hole is arranged on the inner side of the wall;

FIG. 2 is a cross-sectional view of a loudspeaker arrangement in which a gas-permeable and liquid-impermeable panel covering the vent hole is arranged on a carrier;

FIG. 3 is a cross-sectional view of a loudspeaker arrangement in which a gas-permeable and liquid-impermeable panel covering the vent hole is arranged on the outer side of the wall; and

FIG. 4 is a cross-sectional view of an exemplary membrane embodiment.

### DETAILED DESCRIPTION OF THE INVENTION

A loudspeaker arrangement includes an enclosure 1 which may have the form of a generally rectilinear box, having six rigid, gas-impermeable and liquid-impermeable walls (only four of which are shown in the drawings), and may be formed of wood, plastics or any other suitable material. A loudspeaker opening 2 (e.g., circular) is formed in the front wall, and a loudspeaker 3 is affixed in the opening as by bolts (not shown) to direct sound 4 reproduced thereby forwardly from the enclosure 1. The loudspeaker 3 includes a speaker cone 5 coaxial therewith, which generally seals the opening of the front wall, and which is vibrated 6 by a motor system 7 to generate the sound 4. The rearward face of the cone 5 is exposed to the interior of the enclosure 1 through openings (not shown) formed in a speaker frame 8, so that the vibration 6 of the cone 5 also vibrates the air within the enclosure. The necessary electrical connections to the loudspeaker 3 may be made by any suitable means (not shown).

In the present example, a vent hole 9 is formed in the rear wall but may be provided in any one of the walls of the enclosure 1. The vent hole 9 is covered by a protective panel 8 which is arranged at the vent hole 9 on the inner side of the rear wall and sealingly secured to the enclosure 1 by, for instance, adhesive bonding. The panel 8 includes at least one gas-permeable, liquid-impermeable membrane which is, thus, permeable to air and vapor but repellent to water and dirt and which will be described below in more detail.

In the present example, the panel 8 is an expanded Polytetrafiuoroethylene (ePTFE) membrane without backing material. The panel 8 is, for instance, a solitary semi-permeable disc-like membrane of ePTFE of sufficient rigidity and, thus, without any supporting structure (e.g., substrate), which may be bonded, heat staked or ultrasonically welded over the vent hole 9.

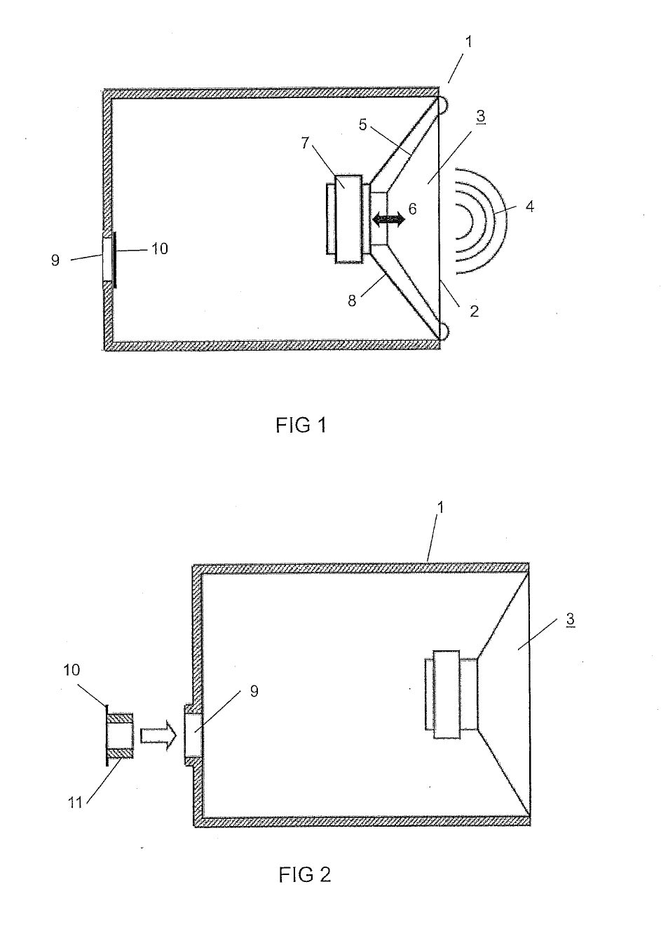

A modification of the arrangement of FIG. 1 is depicted in FIG. 2. In the modified arrangement, the vent hole 9 has a port-like structure that is configured to receive a tubular carrier 11 to which the panel 10 is bonded against a forward surface of the carrier 11 by, for instance, ultra-sound bonding. The carrier 11 may be secured in the vent hole 9 by, for instance, a threaded connection.

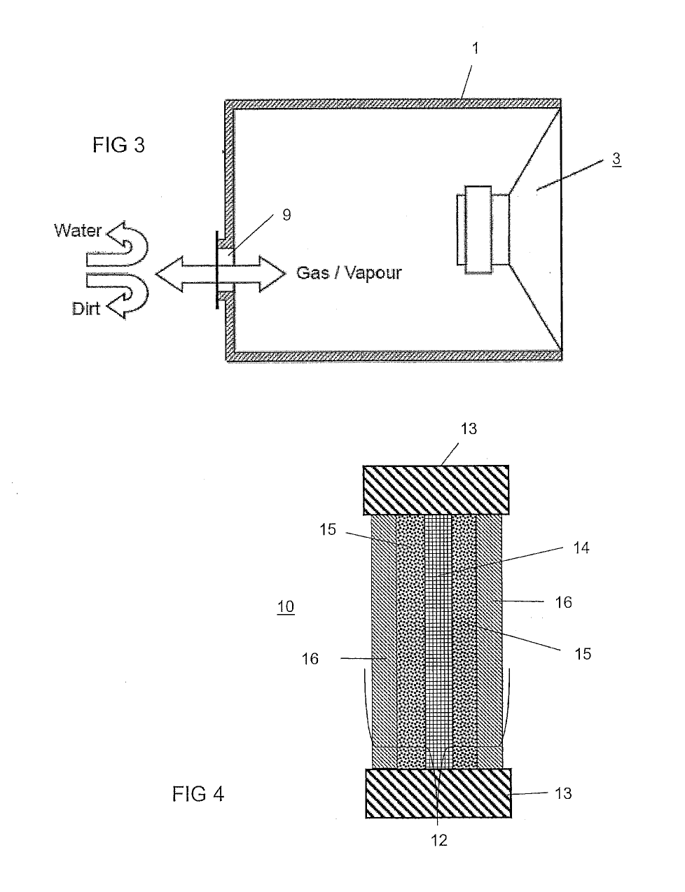

A vent hole 9 having a port-like structure is also employed the arrangement depicted in FIG. 3. However, the panel 10 is secured bodily against a forward surface of the outer end of the tubular vent hole 9 by, for instance, screws (not shown).

Reference is now made to FIG. 4, in which an embodiment of the carrier-mounted panel 10 is depicted in more detail. The panel 10 includes a multi-layer membrane 12 that is secured to a frame 13. The frame 13 may form the carrier 11 or part thereof. In the present example, five sheet-like layers overlying the entire area of the panel 11 are used: a central substrate (or support) layer 14, two gas-permeable and liquid-impermeable layers 15 arranged on both sides of the substrate layer 14, and two outer layers 16. The layers may be laminated for mechanical stability.

The substrate layer 14 is gas-permeable (and liquid-permeable) and may be made from woven material, nonwoven material, or mesh material. These materials may be rigid to some extent in order to provide certain form stability of the panel 11. The two outer layers 16 are made from, for instance, synthetics of the type commonly used for outdoor carpeting. Water may pass through material of this sort with relative ease, and the layers 16 would hence not, of itself alone, adequately protect the loudspeaker 3 against moisture, but provide mechanical protection for the panel 11 itself. The membrane 12 also includes the two layers 15 of a very closely woven moisture-repellent textile fabric or porous material that may comprise a hydrophobic material such as Polytetrafiuoroethylene (PTFE) or expanded Polytetrafiuoroethylene (ePTFE).

In the present example, the edges of layers 14, 15, 16 are adhered to the frame 13 by adhesive so that water cannot work around the edges of the layers 14, 15, 16, but, alternatively, may be clamped respectively between the parts of a multi-part frame, or secured to the frame by any other suitable means. The layers may be laminated or supported in closely spaced apart, parallel relation. Furthermore, the outer layers 16 may be folded rearwardly around the edges of the frame 13 and secured to the rearward surface thereof as by tacks.

Alternatively (not shown), the membrane may be made of a two layer 100% Polyester woven or nonwoven fabric with a substrate layer with a 1.0 micron pore size. This is a Gore-Tex membrane which has a minimum water entry pressure of 10 psi and a porosity of 95%. The membrane can also be made of a two-layer 100% polyester woven fabric, with a 3.0 micron meter pore size, minimum water entry pressure of 2 psi and a porosity of 95%. These membranes may use a substrate layer made of filmed TEFLON®. Fabrics with a pore size for the substrate of 1.0 micrometer to 3.0 micrometers are the parameters of this membrane. A woven or nonwoven Polyester can be used or any fabric that will allow a Polytetrafluoroethylene substrate layer to be attached to it. This fabric may be ultrasonically attached to the frame 13.

Gore-Tex® is a waterproof/breathable fabric, and a registered trademark of W. L. Gore and Associates. For further details regarding Gore-Tex membranes, it is referred to U.S. Pat. No. 3,953,566 for a porous form of Polytetrafluoroethylene (the chemical constituent of Teflon) with a micro-structure characterized by nodes interconnected by fibrils, and U.S. Pat. No. 4,194,041 for a “waterproof laminate.” However, other gas-permeable and liquid-impermeable (also called semi-permeable or waterproof/breatheable) materials may be used, for instance, directional fabrics such as eVent™, Epic™, Nikwax™ or FurTech™ which are also waterproof/breatheable in the conventional sense.

The selection of the structure (e.g., number and kind of layers) and materials of the membrane may be guided by the considerations that the membrane should allow flow of gas through the membrane only at a limited rate which is such that pressure equalization between the hollow interior and the ambience of the enclosure requires at least 1 second, e.g. at least 0.5, 1, 2, 5 or even 10 minutes. The use of such a semi-permeable (waterproof/breatheable) membrane as a vent in a loudspeaker enclosure allows gradual equalization of pressure differential due to temperature and air pressure fluctuations, whilst acting as a resistant barrier to air flow during transient pressure fluctuations when the loudspeaker is in operation.

The arrangement disclosed herein allows continuous pressure venting of a loudspeaker enclosure whilst, for the purposes of loudspeaker operation, maintains an effectively airtight enclosure. Using a semi permeable membrane across the vent hole prevents water and dirt ingress and allows gradual equalization of pressure differentials as environmental conditions vary. But because the membrane has an inertial effect on the pressure transmission, the transient pressure differentials arising from the speaker piston operation are too quick for the membrane to permit any significant pressure transfer, resulting in an enclosure that is effectively acoustically sealed.

Although various examples of realizing the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Such modifications to the inventive concept are intended to be covered by the appended claims.

Although the present invention has been illustrated and described with respect to several preferred embodiments thereof, various changes, omissions and additions to the form and detail thereof, may be made, without departing from the spirit and scope of the invention.

What is claimed is:

1. A loudspeaker arrangement comprising:
an enclosure having rigid walls in which a loudspeaker opening and a vent hole are formed;
a loudspeaker which is arranged in or at the loudspeaker opening and sealingly secured to the enclosure; and
a protective panel which is arranged in or at the vent hole and sealingly secured to the enclosure, the panel comprises at least one gas-permeable and liquid-impermeable membrane.

2. The loudspeaker arrangement of claim 1, in which the membrane allows flow of gas through the membrane at a limited rate which is such that pressure equalization between the hollow interior and the ambience of the enclosure requires at least 1 second.

3. The loudspeaker arrangement of claim 2, in which the membrane allows flow of gas through the membrane at a limited rate which is such that pressure equalization between the hollow interior and the ambience of the enclosure requires at least 1 minute.

4. The loudspeaker arrangement of claim 1, in which the membrane is sealingly secured to the enclosure using a carrier which is sealingly secured to both the membrane and the enclosure.

5. The loudspeaker arrangement of claim 1, in which the membrane comprises a porous material.

6. The loudspeaker arrangement of claim 5, in which the porous material comprises a hydrophobic material.

7. The loudspeaker arrangement of claim 6, in which the hydrophobic material is Polytetrafiuoroethylene.

8. The loudspeaker arrangement of claim 7, in which the hydrophobic material is expanded Polytetrafiuoroethylene.

9. The loudspeaker arrangement of claim 8, in which the panel is a solitary membrane.

10. The loudspeaker arrangement of claim 1, in which the membrane comprises at least two sheet layers.

11. The loudspeaker arrangement of claim 10, in which the membrane comprises laminated sheet layers.

12. The loudspeaker arrangement of claim 10, in which one of the layers is a gas-permeable substrate or support layer.

13. The loudspeaker arrangement of claim 12, in which the gas-permeable substrate or support layer is selected from a group consisting of woven material, nonwoven material, and mesh material.

14. The loudspeaker arrangement of claim 10, in which at least two of the sheet layers are liquid-impermeable.
